(19) United States
(12) Patent Application Publication
(10) Pub. No.: US 2022/0048536 A1
(43) Pub. Date: Feb. 17, 2022

(54) METHOD AND DEVICE FOR TESTING A DRIVER ASSISTANCE SYSTEM

(71) Applicant: AVL LIST GMBH, Graz (AT)

(72) Inventors: Emre KAPLAN, Istanbul (TR); Andrea LEITNER, Graz (AT); Ahmetcan ERDOGAN, Istanbul (TR); Markus NAGER, Graz (AT)

(21) Appl. No.: 17/287,814

(22) PCT Filed: Oct. 23, 2019
(86) PCT No.: PCT/EP2019/078898

§ 371 Date: Nov. 1, 2021

(30) Foreign Application Priority Data
Oct. 24, 2018 (AT) A50922/2018

(51) Int. Cl. B60W 60/00; B60W 50/14

(52) U.S. Cl. CPC B60W 60/0011; B60W 2050/143; B60W 50/14

(57) ABSTRACT

The invention relates to a method and to a device for testing a driver assistance system for a vehicle in a test environment. Traffic scenario descriptions are determined, which each characterize a certain traffic scenario and comprise at least one parameter, by means of which the traffic scenario in question can be adapted to constraints. The traffic scenario descriptions are stored in a traffic scenario file, in which the at least one parameter is stored in a predefined format. At least one traffic scenario description is selected on the basis of an input of a user and/or specified criteria. Furthermore, a test case is produced on the basis of the at least one selected traffic scenario description and at least one specified value for the at least one parameter. The test case corresponds to a specific realization of the traffic scenario characterized by the at least one selected traffic scenario description, with respect to the at least one specified value of the at least one parameter, and is suitable for producing a test environment in which a driver assistance system can be subjected to a test run. A test run can be carried out using the produced test case.

The present invention relates to a method and a device for testing a driver assistance system for a vehicle in a test environment.

Modern vehicles are increasingly being equipped with advanced driver assistance systems (ADAS) which support the driver in certain driving situations. The support ranges from merely displaying potentially relevant information (e.g. a lane change assistant issuing a warning) to semi-autonomous interventions (e.g. an anti-lock braking system regulating the torque applied to the axles) to fully autonomous interventions in the vehicle control (e.g. an adaptive cruise control (ACC) adaptively regulating velocity).

Usually forming the basis for such driver assistance systems is sensor data such as signals provided by ultrasonic sensors, radar sensors or cameras, on the basis of which the present driving situation can be determined and the function of the respective driver assistance system performed in response. Particularly in the case of driver assistance systems which (autonomously) intervene in the control of the vehicle, the present driving situation must be able to be classified with the highest possible reliability based on the sensor data.

In general, certain rules or respectively criteria associated with a driving situation are thereby established which, if met, enables concluding that a known driving situation exists. Satisfying the rule or respectively criteria thereby acts for example as a trigger for an action of the driver assistance system. For example, in a traffic scenario in which a nearby vehicle ahead of the vehicle equipped with the driver assistance system (the ego vehicle) merges into the same lane, it can thereby be recognized that a sensor-recorded transverse distance perpendicular to the neighboring vehicle's direction of travel decreases and ultimately at least substantially reaches the value of 0 when the neighboring vehicle is located directly in front of the ego vehicle.

To test such driver assistance systems, in particular their response in already known traffic scenarios, labeled sensor data relative to a known traffic scenario is generally provided and the driver assistance system to be tested fed said labeled sensor data. A multitude of sensor data, which may potentially also characterize slight variations in the traffic scenario, is normally required in order to reliably test the driver assistance system.

The automatic generation of simulation scenarios for validating a driver assistance system is known from WO 2017/210222 A1 to that end. A plurality of such simulation scenarios can thereby be generated particularly by the varying of recorded scenarios, wherein the variations are based on a data stream produced by isolating differences between similar recorded scenarios.

A task of the present invention is that of further improving the testing of driver assistance systems, in particular simplifying and/or making same more flexible.

This task is solved by a method and a device for testing a driver assistance system for a vehicle in a test environment according to the independent claims. Advantageous embodiments of the invention are the subject of the dependent claims.

A first aspect of the invention relates to a method, particularly a computer-based method, for testing a vehicle driver assistance system in a test environment which comprises the following procedural steps: (i) determining traffic scenario descriptions, each characterizing a specific traffic scenario, particularly a cut-in maneuver or a cut-out maneuver, and comprising at least one parameter by means of which the respective traffic scenario can be adapted to boundary conditions, wherein particularly each of the traffic scenario descriptions are preferably stored in a traffic scenario file in which the at least one parameter is stored in a predefined, in particular generic, format; (ii) selecting at least one traffic scenario description on the basis of a user input, in particular an indication of the at least one parameter or at least a value or range of values for the at least one parameter entered by the user, and/or predetermined criteria; and (iii) producing a test case on the basis of the at least one selected traffic scenario description and at least one predetermined value for the at least one parameter, particularly as entered by the user, and preferably further traffic scenario descriptions, wherein the test case corresponds to a concrete realization of the traffic scenario characterized by the at least one selected traffic scenario description and preferably further traffic scenarios with respect to the at least one predetermined value of the at least one parameter and is suitable for producing a test environment in which a driver assistance system can be subjected to a test run.

A boundary condition in the sense of the invention is in particular a traffic situation, a weather condition, an initial speed of the vehicle with the driver assistance system to be tested (hereinafter: test vehicle) and/or other road users, a geometry or respectively course of a road, a distance of the test vehicle from one or more other road users, a configuration of the test vehicle and/or other road users such as for instance a load, e.g. a trailer, and/or the like. A boundary condition can in particular be any conceivable factor which influences control of the vehicle equipped with the driver assistance system via said driver assistance system.

A test case within the meaning of the invention is in particular a script, e.g. a sequence of road user actions enabling a test of a driver assistance system. A test case can for example be a script based on which a simulation for testing the driver assistance system can be realized.

A test environment in the sense of the invention is in particular the content of a simulation which generates a concrete (virtual) realization of a traffic scenario. In other words, a test environment can for example be a simulated environment of the test vehicle in which at least the other road users, and potentially also the test vehicle itself, move in a predefined manner, in particular execute predetermined actions.

A predefined format in the sense of the invention is in particular a predefined (data) structure. A predefined format can for example correspond to a specific formula, e.g. a specific arrangement or sequence of multiple parameters and/or a specific coding of the at least one parameter in the traffic scenario file. It is for instance conceivable for a plurality of parameters to be stored in a table, particularly a two- or three-dimensional or perhaps even multi-dimensional matrix.

A determining of traffic scenario descriptions within the meaning of the invention is in particular a recording, e.g. when performing actual or simulated trials. Determining traffic scenario descriptions can however also be an importing, e.g. from databases and/or the like.

The invention is in particular based on the approach of selecting at least one traffic scenario description from preferably multiple traffic scenario descriptions, each characterizing a specific traffic scenario and preferentially existing in a predefined, in particular generic, format and, on the basis of same, producing at least one test case so as to generate a test environment suitable for testing a driver assistance system. The traffic scenarios characterized by the traffic scenario descriptions thereby preferably correspond to specific traffic scenarios such as cut-in maneuvers (merging in) or cut-out maneuvers (merging out). The traffic scenario descriptions describe the respective traffic scenario in a preferred manner, albeit in a general generic form, without the descriptions thereby specifying a concrete execution of said maneuver. On the other hand, the test case preferentially corresponds to a concrete realization of the traffic scenario characterized by the at least one selected traffic scenario description.

Thus, both the at least one traffic scenario description can be selected on the basis of a user input, for example by specifying at least one parameter or input values or value ranges for one or more parameters which adapt, in particular define, boundary conditions of the traffic scenarios as well as the at least one test case thereby produced from the at least one selected traffic scenario description. The parameters can thereby serve for example as variables in the traffic scenarios.

The user can for example input that the test vehicle; i.e. the vehicle equipped with the driver assistance system, drive straight ahead in a first lane at a constant speed selected by the user and be passed by another vehicle in an adjacent second lane, wherein the other vehicle merges into the first lane at a distance from the test vehicle selected by the user. Based on these inputs, a database of stored traffic scenario files which contain the traffic scenario descriptions in the predetermined format can thereafter be searched in order to select traffic scenario descriptions with which the concrete traffic scenario characterized by the user input can be implemented. The parameters and/or boundary conditions entered by the user can then be plugged into the at least one selected traffic scenario description, akin to values in a mathematical function for instance, in order to produce at least one test case with which a simulation can be realized and the driver assistance system thereby tested.

Being able to select at least one traffic scenario description, particularly a plurality of traffic scenario descriptions, via user input enables dispensing with a potentially complex scenario-specific or maneuver-specific preparing of datasets for generating test environments. According to the invention, test runs for testing a driver assistance system can thus be effected particularly readily and quickly and/or in large numbers. Particularly because the traffic scenario descriptions can be stored in a predefined, preferably generic, format, access to a wide range of traffic scenarios is enabled.

Overall, the invention enables further improving the testing of driver assistance systems, in particular simplifying and/or making same more flexible.

Preferred embodiments of the invention and their further developments are described in the following which, unless expressly excluded, can be combined with one another as desired as well as with the aspects of the invention described below.

In one preferred embodiment, the method furthermore comprises the following procedural step: conducting a test run using the test case as produced. The driver assistance system can thereby be reliably tested, particularly on the basis of a specifically adapted traffic scenario.

In a further preferred embodiment, the method furthermore comprises the following procedural step: (i) determining at least one dataset which characterizes at least one, in particular real, traffic scenario; and (ii) identifying at least one parameter in the at least one determined dataset by means of which the respective traffic scenario can be adapted to boundary conditions, in particular to an initial speed of an ego vehicle to which the traffic scenario relates. As defined by the invention, an ego vehicle is in particular a vehicle from the perspective of which the traffic scenario, in particular real traffic scenario, ensues.

Identifying at least one parameter in the at least one dataset enables a particular reliable subsequent selection of at least one traffic scenario description from a plurality of traffic scenario descriptions based on user input. In particular, at least one traffic scenario can thus be selected on the basis of the identified parameter, e.g. all traffic scenario descriptions characterizing a traffic scenario corresponding to a determined dataset and therefore also exhibiting the identified parameters. In other words, the number of possible traffic scenarios relevant to testing the driver assistance system can in this way be increased.

The at least one dataset is thereby preferably determined on the basis of a sensor data stream generated for example by a sensor device for recording the (real) vehicle environment of the ego vehicle, in particular extracted from the sensor data stream. For example, the sensor data stream can thereby be processed so as to classify the vehicle environment of the ego vehicle, thus, for example, recognize and label objects such as other road users, traffic signs, obstacles and/or the like. The at least one dataset can then be generated from the processed sensor data stream. In other words, the at least one determined dataset is preferably based on prepared sensor data which was generated during the capturing of a real vehicle environment and contains additional meta-information; i.e. information derived from raw data and therefore going beyond the purely physical information contained in the sensor data stream. In particular, this meta-information allows the identification of the at least one parameter by means of which the respective traffic scenario can be adapted to boundary conditions.

In a further preferred embodiment, the at least one parameter is identified by comparison of a classified vehicle environment in chronologically consecutive scenes of the at least one traffic scenario characterized by the at least one determined dataset. A classified vehicle environment within the meaning of the invention is hereby in particular a description of the surrounding environment of a vehicle which goes beyond purely physical information. The classified vehicle environment, which is preferably characterized by the provided dataset, can thereby in particular contain meta-information enabling the comparison of the classified vehicle environment at different points in time. Preferably, the classified vehicle environment thereby contains meta-information based on which recognized and labeled objects in individual scenes of the at least one traffic scenario characterized by the at least one determined dataset can be identified with e.g. their positions, their speeds, their configuration and/or the like in successive scenes being comparable with one another The at least one parameter can thereby be identified particularly reliably and/or automatically.

Preferably, the states of the vehicle environment elements; i.e. the objects identified in the vehicle environment such as other road users, for example, are derived from the classified vehicle environment in each scene of the at least one traffic scenario characterized by the at least one determined dataset and compared to one another in chronologically consecutive scenes, in particular subtracted from each another. Within the meaning of the invention, a state of an element of the vehicle environment thereby in particular includes at least one physical variable which characterizes the element, in particular relative to the ego vehicle, e.g. the speed of the element, the position of the element, the configuration of the element and/or the like.

Should the state of an element change in successive scenes, the at least one parameter is preferentially identified as the physical variable inducing the change in state. As a result, the at least one parameter is particularly easily identifiable.

For example, the speed and the size of another road user can be taken from the classified vehicle environment in a first scene and compared to the speed/size of said road user in a subsequent second scene. The speed of the road user usually changes over the course of the traffic scenario and can therefore be identified as a parameter. In contrast, the size of the road user does not usually change and is thus not identified as a parameter.

In a further preferred embodiment, the method further comprises the following procedural step: generating at least one traffic scenario description on the basis of the determined dataset or determined datasets, wherein the traffic scenario description characterizes the specific traffic scenario and wherein the at least one identified parameter is stored in the predefined format. Storing the at least one identified parameter in the predefined format, particularly in a traffic scenario file, thereby preferentially corresponds to generating a standardized format or a standardized traffic scenario description respectively. In other words, storing the at least one identified parameter in the predefined format equates to storing a standardized definition of the at least one corresponding traffic scenario characterized by the at least one dataset as determined. An in particular generic form of the at least one dataset extracted from a sensor data stream can thereby be provided as a traffic scenario description and thereafter selected for producing at least one test case.

In a further preferred embodiment, the method furthermore comprises the following procedural step: storing the generated traffic scenario description, in particular the traffic scenario file, in a traffic scenario database, wherein further traffic scenario files are also stored in the traffic scenario database. This traffic scenario database is thereby preferably configured as a No-SQLdatabase and contains a standardized definition of the at least one traffic scenario as characterized by the at least one determined dataset. By storing the generated traffic scenario description in the database, the production of test cases can be based on a plurality of, in particular real, traffic scenarios.

In a further preferred embodiment, the method furthermore comprises at least one of the following procedural steps: (i) determining the predetermined values from a test run database; and/or (ii) determining the predetermined values from a user input, in particular via a user interface. For example, at least one value or range of values for the at least one parameter, which have for example proven constructive in previous tests of a driver assistance system, can be read out from the test run database and used to produce the at least one test case. Alternatively or additionally, a user can specify at least one value or range of values for the at least one parameter upon user input, particularly when inputting the at least one traffic scenario description selection. As a result, test cases can be automatically and quickly produced and/or the user given a high degree of control over the production of the test cases and thus over the testing of the driver assistance system.

A second aspect of the invention relates to a device for testing a vehicle driver assistance system in a test environment which comprises a means for determining traffic scenario descriptions, wherein the traffic scenario descriptions preferably each characterize a specific traffic scenario, particularly a cut-in maneuver or a cut-out maneuver, and comprise at least one parameter by means of which the respective traffic scenario can be adapted to boundary conditions. The means for determining traffic scenario descriptions is moreover preferably configured to store particularly each of the traffic scenario descriptions in a traffic scenario file in which the at least one parameter is stored in a predefined, in particular generic, format. The means for determining traffic scenario descriptions can thereby in particular be configured as an interface or sensor device. In addition, the device preferably comprises a means for selecting at least one traffic scenario description on the basis of a user input and/or predetermined criteria, wherein the means for selecting at least one traffic scenario description can in particular be designed as a first module of a data processing device, e.g. as corresponding software. Additionally, the device preferably comprises a means for producing a test case on the basis of the at least one selected traffic scenario description and at least one predetermined value for the at least one parameter and preferably further traffic scenario descriptions, wherein the test case corresponds to a concrete realization of the traffic scenario characterized by the at least one selected traffic scenario description and preferably further traffic scenarios relating to the at least one predetermined value of the at least one parameter and is suitable for producing a test environment in which a driver assistance system can be subjected to a test run. The means for producing the test case can in particular be configured as a second module of the data processing device, e.g. as corresponding software.

In the sense of the invention, a means can be of hardware and/or software design, particularly a processing unit, in particular microprocessor unit (CPU), preferably connected in particular digitally to a memory and/or bus system in terms of data/signals or a module of such and/or comprise one or more programs or program modules. The CPU can be designed to process commands implemented as a program stored in a memory system, capture input signals from a data bus and/or send output signals to a data bus. A storage system can comprise one or more, in particular different, storage media, particularly optical, magnetic, solid-state and/or other non-volatile media. The program can be such that it embodies or is capable of implementing the methods described herein so that the CPU can execute the steps of such methods and thus in particular control and/or monitor a reciprocating piston engine.

In one preferred embodiment, the device comprises a traffic scenario database in which traffic scenario descriptions are or are to be stored in the form of traffic scenario files, each containing at least one parameter in a predefined, in particular generic, format, by means of which a traffic scenario characterized by the respective traffic scenario description can be adapted to boundary conditions.

In a further preferred embodiment, the device also comprises an input device by means of which a user can make an input for the selection of at least one traffic scenario description, in particular from traffic scenario descriptions stored in the traffic scenario database.

In a further preferred embodiment, the device comprises a simulation device configured to implement a test run using the generated test case. The simulation device can for example thereby exhibit a simulation environment such as MATLAB/Simulink, IPG CarMaker, PreScan, SUMO SCANer or Virtual Test Drive (VTD).

The features and advantages described with respect to the first aspect of the invention and advantageous embodiment thereof also apply, at least where technically reasonable, to the second aspect of the invention and advantageous embodiment thereof and vice versa.

Further features, advantages and possible applications of the invention will be evident from the following description in conjunction with the figures, in which the same reference numerals are used throughout for the same or corresponding elements of the invention. Shown at least partially schematically therein are:

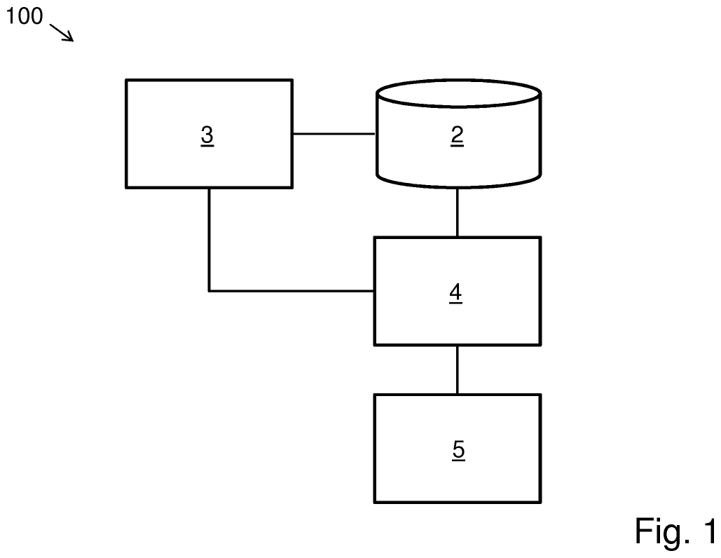

FIG. 1 a preferred embodiment of a device according to the invention;

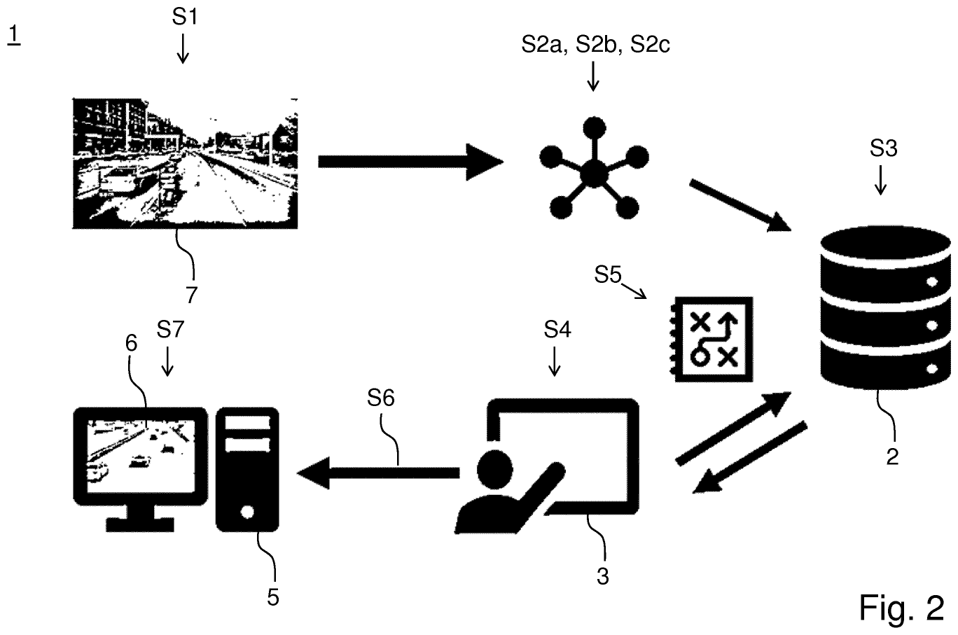

FIG. 2 a preferred embodiment of a method according to the invention; and

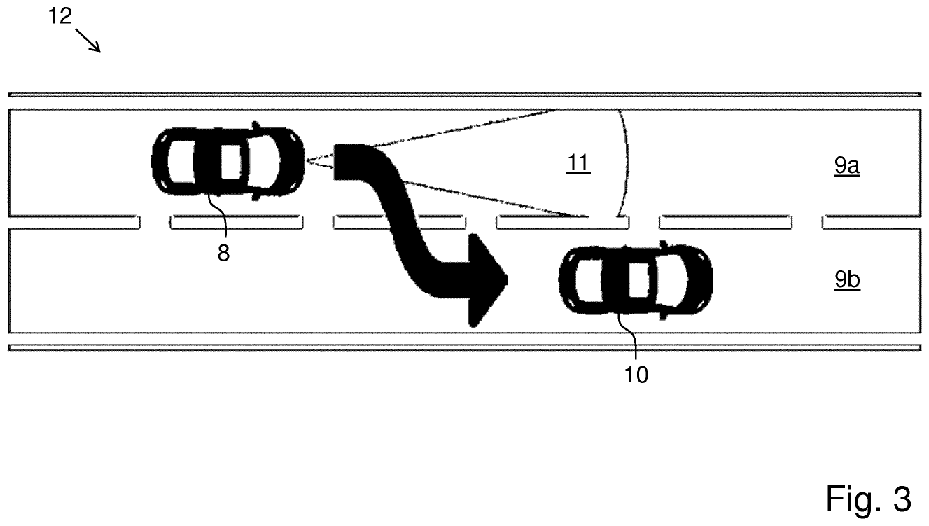

FIG. 3 an example of a traffic scenario description.

FIG. 1 shows a preferred embodiment of an inventive device 100 for testing a driver assistance system for a vehicle in a test environment. The device 100 comprises a traffic scenario database 2 having traffic scenario descriptions stored therein, each characterizing a specific traffic scenario, an input device 3 for selecting at least one of the traffic scenario descriptions stored in the traffic scenario database 2, a data processing device 4 for creating a test case corresponding to a concrete realization of the traffic scenario characterized by the at least one selected traffic scenario description on the basis of said at least one selected traffic scenario description, and a simulation device 5 for performing a test run using the generated test case, in particular a test environment produced on the basis of the test case.

Each of the traffic scenario descriptions preferably generically characterize a specific traffic scenario, for example a cut-in maneuver or a cut-out maneuver. In other words, each traffic scenario description is preferably an abstract representation of a traffic scenario, in particular at least one concrete driving maneuver of a vehicle taking part in the traffic scenario.

The traffic scenario descriptions are preferably stored in the traffic scenario database 2 in the form of traffic scenario files. Due to the preferred generic character of the traffic scenario descriptions, the traffic scenario files can be stored in a predefined, in particular generic, format independently of the respectively characterized (specific) traffic scenario. This thereby enables or at least simplifies e.g. an identification and/or a parameterization of the traffic scenario characterized by the respective traffic scenario description.

The traffic scenario descriptions stored in the traffic scenario database 2 can to that end comprise for example at least one parameter, for instance speeds and/or positions of the road users included in the traffic scenario, with which the respective traffic scenario can be adapted to boundary conditions. Preferentially, the at least one respective parameter is contained in the traffic scenario files. In particular, the predetermined format of the traffic scenario files can correspond to the predetermined format of the at least one parameter with which the at least one parameter is stored in the traffic scenario file. In other words, the predetermined format of the traffic scenario files can be predetermined or respectively formed by the structure with which the at least one parameter is stored in the traffic scenario database 2. This thereby enables the parameterization of the traffic scenarios.

At least one traffic scenario description can also be selected via the at least one parameter contained in each of the traffic scenario files. For example, via the input device 3, a user can enter or respectively specify at least one parameter to be factored in when creating test cases. It is in particular conceivable for the user to input at least one value or range of values for the at least one parameter via the input device 3 so that those traffic scenario descriptions exhibiting the corresponding parameter, or where the corresponding parameter is respectively capable of assuming the entered value or value range, can be selected in the database.

To that end, the input device 3 can for example comprise a graphical user interface in which the user can provide information on the selection of the at least one traffic scenario description, particularly with respect to the at least one parameter. The input device 3 is thus preferentially used as a user interface.

The data processing device 4 is preferably configured to factor in at least one predetermined value for the at least one parameter for producing the test case on the basis of the at least one selected traffic scenario description, wherein the at least one predetermined value can be provided by e.g. the input device 3. By specifying at least one value for the at least one parameter, the traffic scenario characterized by the selected, preferably generic or respectively abstract, traffic scenario description can be concretized so that the test case preferentially corresponds to a specific realization of the traffic scenario.

Based on the test case produced by the data processing device 4, the simulation device 5 can preferentially produce a test environment in which a driver assistance system can be subjected to a test run. For example, the simulation device 5 can simulate a virtual, in particular dynamic, vehicle environment on the basis of the generated test case in which the reaction of the driver assistance system is tested in the traffic scenario concretized by the test case. The parameterization of the traffic scenarios, which are each characterized by a traffic scenario description, accordingly allows the testing of the driver assistance system under different conditions, e.g. in different weather conditions, on different segments of road, at different vehicle speeds, with or without a trailer and/or the like.

FIG. 2 shows a preferred embodiment of an inventive method 1 for testing a driver assistance system for a vehicle in a test environment 6. A sensor data stream 7 preferably generated by means of a sensor device when detecting a real vehicle environment is thereby processed In method step S1. The sensor data stream 7 can in particular be processed such that parameterizable datasets, each characterizing at least one traffic scenario, are generated and can be stored in a database 2 as traffic scenario descriptions, in particular generic traffic scenario descriptions. These traffic scenario descriptions serve in the following as the basis for producing at least one test case with which the test environment 6 can be produced for testing the driver assistance system.

Preferably, the sensor data stream 7 is processed in step S1, in particular analyzed, e.g. by classifying the vehicle environment mapped by the sensor data stream 7. Elements of the vehicle environment can for example thereby be recognized and labeled in individual snapshots of the vehicle environment which correspond to the individual scenes of a real (specific) traffic scenario obtained via sensor data fusion. So-called meta-information is thus generated which goes beyond the purely physical information resulting from the sensor-based recording of the vehicle's environment. Able to be generated in this context are, for example, object lists of objects recognized in the vehicle environment, for instance other road users or traffic signs. Such processing of the sensor data stream 7 can be implemented for example using a rule-based approach in which predetermined events are recognized and labeled.

In other words, preferably produced on the basis of the sensor data stream 7 is an environment model which represents e.g. the objects around the ego vehicle equipped with the sensor device.

In a further method step S2a, based on the sensor data stream 7 thusly processed, in particular from the meta-information thereby generated such as for instance an object list, at least one dataset characterizing the at least one traffic scenario recorded by the sensor device can be determined. For example, processed sensor data corresponding to individual traffic scenarios identified for instance via recognized predetermined events can then be selectively extracted from the sensor data stream 7. This can also be referred to as scenario mining.

In a further method step S2b, at least one parameter is preferably identified for the at least one determined dataset, by means of which the at least one traffic scenario characterized by the at least one determined dataset can be adapted to boundary conditions, for instance a weather condition, a speed of the ego vehicle and/or the like. In other words, the at least one traffic scenario characterized by the at least one determined dataset can be parameterized.

The at least one parameter can for example be identified by determining the states of the vehicle environment's elements from the classified vehicle environment; i.e. the at least one dataset, for instance recognized objects such as other road users, and comparing them to one another in successive scenes of the traffic scenario characterized by the at least one dataset. This thereby enables defining a vehicle environment's element state, for example through physical variables such as speed, position, configuration and/or the like. At least one parameter is preferentially identified particularly upon a change in an element's state in the chronologically consecutive scenes of the traffic scenario, e.g. a change in speed or position.

Since the traffic scenario description is preferentially defined by the dataset determined in method step S2a and the at least one parameter identified in method step S2b, method steps S2a and S2b can also be understood as a determining of traffic scenario descriptions and method step S2c as a summarizing. Alternatively or additionally, however, such traffic scenario descriptions can also be otherwise determined, for instance from other databases such as NCAP, DVP and/or accident databases (not shown).

In a further method step S3, the at least one dataset with the at least one thusly parameterized traffic scenario is stored in a traffic scenario file as an in particular generic traffic scenario description and saved to the traffic scenario database 2. The at least one identified parameter in particular can thereby be stored in a predetermined, in particular generic, format in the traffic scenario file.

In a further method step S4, at least one of the traffic scenario descriptions as determined and stored in the traffic scenario database 2 can then be selected by user input, for instance via an input device 3. For example, the user can specify at least one parameter with which the traffic scenarios characterized by the traffic scenario descriptions can be adapted to boundary conditions.

The at least one traffic scenario description relevant to or respectively selected in respect of the user input is provided to a data processing device which produces at least one test case in a further method step S6 on the basis of said traffic scenario description and at least one value for the at least one parameter, in particular predetermined by user input, which corresponds to a concrete realization of the traffic scenario characterized by the at least one selected traffic scenario description. The at least one produced test case can be used to generate a test environment for testing the driver assistance system.

The user can thereby influence, in particular configure, the test of the driver assistance system via his input, for example by specifying boundary conditions for the traffic scenario characterized by the at least one traffic scenario description, in particular the course of the traffic scenario, e.g. the resolution of a traffic situation. For example, the user can to that end select appropriate parameters on the basis of which the at least one test case is created. It is in particular conceivable for the user to directly select relevant traffic scenario descriptions via input and modify at least one value or value range of a respective parameter, e.g. through specification.

Such modified traffic scenario descriptions can be stored in the traffic scenario database in a further method step S5, potentially along with generated test cases, where they can be selected at a later point in time for in particular faster test case production.

In a further method step S7, a test environment 6 for testing a driver assistance system, for example a virtual vehicle environment, is generated from the at least one test case produced by means of a simulation device 5. The simulation device 5 can exhibit a simulation environment such as MATLAB/Simulink, IPG CarMaker, PreScan, SUMO SCANer or Virtual Test Drive (VTD) to that end. The test environment 6 can thereby be produced independently of the simulation environment employed since the traffic scenario descriptions are stored in the traffic scenario database 2 as traffic scenario files in a predetermined, particularly generic, format and the test cases can correspondingly also be produced in a standardized format, e.g. the OpenSCENARIO format.

It is pointed out that the exemplary embodiments are merely examples which are in no way to be limiting of protective scope, application and configuration. Rather, the preceding description affords one skilled in the art a guideline for the implementation of at least one exemplary embodiment, whereby various modifications can be made, in particular with regard to the function and arrangement of the described components, without departing from the protective scope as results from the claims and equivalent combinations of features.

FIG. 3 shows an example of a traffic scenario description 12 [PP1] in a schematic depiction. Preferentially, the depicted traffic scenario description 12 corresponds to a general description of a specific traffic scenario, particularly a driving maneuver such as a cut-in maneuver (merging in maneuver) in the shown example, in which an ego vehicle 8, to which the traffic scenario relates, merges from a first lane 9a into a second adjacent lane 9b behind a vehicle 10 in front, as indicated by the arrow. A driver assistance system, e.g. an adaptive cruise control (ACC), can for example be tested for its reaction during and/or after the merging on the basis of a corresponding traffic scenario description 12.

Such a traffic scenario description 12 characterizing a traffic scenario can be determined in different ways. For example, traffic scenario descriptions can be loaded from NCAP, DVP and/or accident databases. Alternatively or additionally, sensor data characterizing the traffic scenario can be collected, for instance by performing appropriate simulations or by the ego vehicle 8 equipped with a sensor device for recording the vehicle environment completing a test drive and a section corresponding to the traffic scenario being extracted as sensor data from a sensor data stream produced by the sensor device.

With respect to the cut-in maneuver, the sensor data stream is for example characterized by the vehicle 10 in front suddenly being recorded at the center of a detection range 11 of a sensor unit of the sensor device, for instance a lidar sensor, upon the change in lanes 9a, 9b. This event can therefore be considered as a trigger for the cut-in maneuver and, preferably together with further suitable triggers, used to extract the sensor data from the sensor data stream.

On the basis of the thusly extracted sensor data, parameters are preferably thereafter identified which define the boundary conditions of the traffic scenario, for example the speed of the ego vehicle 8 and the vehicle 10 in front, the distance of the ego vehicle 8 from the vehicle 10 in front at the start and/or end of the cut-in maneuver, the respective lanes 9a, 9b used by the vehicles 8, 10 and/or the like. The parameters thusly identified preferentially define how the cut-in maneuver ensues.

The parameters can thereby in particular be identified by comparing, in particular subtracting from one another, different states of the two vehicles 8, 10 as defined by the parameters and occurring during the course of the traffic scenario, particularly at the start and end of the traffic scenario.

The thusly identified parameters are preferentially stored at least as part of the traffic scenario description 12 in a traffic scenario file, which together with other traffic scenario files, e.g. from NCAP, DVP and/or accident databases, forms a traffic scenario database. Preferably, the traffic scenario file is provided with a tag which identifies the traffic scenario description 12 stored in the traffic scenario as corresponding to a cut-in maneuver.

To produce a test case based on which a test environment can be generated in which the driver assistance system of the ego vehicle 8 (hereinafter referred to as test vehicle as it is equipped with the driver assistance system to be tested) can be tested, the traffic scenario description 12 of the cut-in maneuver, having been determined as described above, can be selected, e.g. by input of a user, via which all identified traffic scenario descriptions 12 with the respective tag are retrieved. Values for the parameters of the selected traffic scenario description 12 can be predetermined, e.g. likewise by user input or by retrieving from a parameter database. The cut-in maneuver characterized by the selected traffic scenario description 12 is thereupon preferentially adapted to boundary conditions defined by the parameters and/or other criteria, e.g. predetermined via user input.

For example, a value can be predetermined for in particular the lateral speed of the test vehicle 8 which is lower than when capturing the actual cut-in maneuver. Accordingly, the realization of the cut-in maneuver characterized by the test case proceeds more slowly or respectively takes longer. In so doing, at least one value or range of values can also be predetermined for other parameters in order to produce one or more realizations of the cut-in maneuver. Correspondingly, a plurality of different test cases can be readily produced without great effort on the basis of the one traffic scenario description 12.

### LIST OF REFERENCE NUMERALS

1 method
S1-S7 method steps
2 traffic scenario database
3 input device
4 data processing device
5 simulation device
6 test environment
7 sensor data stream
8 ego vehicle/test vehicle
9a, 9b lane
10 other vehicle
11 detection range
12 traffic scenario description
100 device

What is claimed is:

1. A method for testing a driver assistance system for a vehicle in a test environment comprising the following procedural steps:
determining traffic scenario descriptions, each characterizing a specific traffic scenario, particularly a cut-in maneuver or a cut-out maneuver, and comprising at least one parameter by means of which the respective traffic scenario can be adapted to boundary conditions, wherein particularly each of the traffic scenario descriptions are or are to be stored in a traffic scenario file in which the at least one parameter is stored in a predefined, in particular generic, format;
selecting at least one traffic scenario description on the basis of a user input and/or predetermined criteria; and
producing a test case on the basis of the at least one selected traffic scenario description and at least one predetermined value for the at least one parameter and preferably further traffic scenario descriptions, wherein the test case corresponds to a concrete realization of the traffic scenario characterized by the at least one selected traffic scenario description and preferably further traffic scenarios with respect to the at least one predetermined value of the at least one parameter and is suitable for producing a test environment in which a driver assistance system can be subjected to a test run.

2. The method according to claim 1, further comprising the following procedural step:
conducting a test run using the test case as produced.

3. The method according to claim 1, further comprising the following procedural steps:
determining at least one dataset which characterizes at least one, in particular real, traffic scenario; and
identifying at least one parameter in the at least one determined dataset by means of which the respective traffic scenario can be adapted to boundary conditions, in particular to an initial speed of an ego vehicle to which the traffic scenario relates.

4. The method according to claim 3, wherein the at least one parameter is identified by comparison of a classified vehicle environment in chronologically consecutive scenes of the at least one traffic scenario characterized by the at least one determined dataset.

5. The method according to claim 3, further comprising the following procedural step:
generating at least one traffic scenario description the basis of the determined dataset or determined datasets, wherein the traffic scenario description characterizes the specific traffic scenario and wherein the at least one identified parameter is stored in the predefined format.

6. The method according to claim 1, further comprising the following procedural step:
storing the generated traffic scenario description, in particular the traffic scenario file, in a traffic scenario database, wherein further traffic scenario files are also stored in the traffic scenario database.

7. The method according to claim 1, further comprising at least one the following procedural steps:
determining the predetermined values from a test run database; and/or
determining the predetermined values from a user input, in particular via a user interface.

8. A device for testing a driver assistance system for a vehicle in a test environment comprising:
means, particularly an interface or sensor device, for determining traffic scenario descriptions, which each characterize a specific traffic scenario, particularly a cut-in maneuver or a cut-out maneuver and comprise at least one parameter by means of which the respective traffic scenario can be adapted to boundary conditions, and preferably for storing particularly each of the traffic scenario descriptions in a traffic scenario file in which the least one parameter is stored in a predetermined, in particular generic, format;
means, particularly a first module of a data processing device, for selecting at least one traffic scenario description on the basis of a user input and/or predetermined criteria; and
means, particularly a second module of a data processing device, for producing a test case on the basis of the at least one selected traffic scenario description and at least one predetermined value for the at least one parameter and preferably further traffic scenario descriptions, wherein the test case corresponds to a concrete realization of the traffic scenario characterized by the at least one selected traffic scenario description and preferably further traffic scenarios relating to the at least one predetermined value of the at least one parameter and is suitable for producing a test environment in which a driver assistance system can be subjected to a test run.
